(19) United States
(12) Patent Application Publication
(10) Pub. No.: US 2016/0119165 A1
(43) Pub. Date: Apr. 28, 2016

(54) METHODS AND SYSTEMS TO MANAGE NETWORK CONNECTIONS

(71) Applicant: NETSNAPPER TECHNOLOGIES SARL, CAPELLEN (LU)

(72) Inventor: Seppo KERONEN, HELSINKI (FI)

(21) Appl. No.: 14/632,458

(22) Filed: Feb. 26, 2015

Related U.S. Application Data
(60) Provisional application No. 62/069,217, filed on Oct. 27, 2014.

(51) Int. Cl. H04L 12/46; H04L 12/24

(52) U.S. Cl. CPC H04L 12/4633; H04L 41/0803; H04L 12/4641

(57) ABSTRACT

Methods and systems to efficiently aggregate two or more access networks to form a virtual access network are disclosed. The resulting virtual access network is more resource-efficient, faster, more reliable, more secure, and provides more functionality than each individual access network. The virtual access network can be created by a client device that includes a client asset management module. The client asset management module can cooperate with a gateway access manager module of a gateway for creating and for operating the virtual access network.

### CROSS REFERENCE TO RELATED APPLICATIONS

The present application claims priority to U.S. Provisional Patent Application No. 62/069,217, filed Oct. 27, 2014, the disclosure of which is incorporated herein by reference in its entirety.

### TECHNICAL FIELD

The present disclosure relates to network management. More particularly, the present disclosure relates to methods and systems to manage network connections.

### BACKGROUND

Packet data communications networks play a significant role in the creation, capture, storage, transmission and consumption of data related to diverse activities such as culture, commerce, information, and communications. However, traditional packet data communications networks suffer from certain inadequacies such as high cost, limited availability, limited capacity, limited speed, limited reliability, and limited functionality.

FIG. 1 shows a prior art communications system 100 that incorporates a packet data communications network 130 to provide communications interconnectivity between one or more user elements (such as a user element (UE) 105) and one or more terminal elements (such as a terminal equipment (TE) 125). The packet data communications network 130 can include an access network 110, a router 115, and a wide area network (WAN) 120.

Typically, the UE 105 sets up an access connection by establishing a communications link 106 to the access network 110. Once established, the communications link 106 can be used to propagate data packets between the UE 105 and the TE 125 in either direction. The connection establishment procedure between the UE 105 and the access network 110 typically depends on the nature of the access network 110 and the network operator administering the access network 110. Understandably, different types of access networks and different types of network operators necessitate the use of different types of connection establishment procedures. These connection establishment procedures generally involve various time-intensive and labor intensive manual entry operations such as, for example, establishing of connection credentials and parameters by the user or administrator of the UE 105. Furthermore, the access network 110 and/or the WAN 120 can suffer from certain limitations that can lead to a variety of interconnectivity problems between the UE 105 and the TE 125. Some of these limitations and/or issues are described below in more detail.

When the access network 110 is a wireless based network, the various limitations include coverage issues, signal quality issues, signal loss issues, cost issues, power consumption issues, and issues related to the physical size of equipment. Consequently, wireless based access networks (such as cellular/mobile phone networks) are generally limited to areas of economically viable population densities. On the other hand, when the access network 110 is a wireline based network, a user of the UE 105 becomes restricted to a certain geographic location and loses the advantages of mobility.

Even in geographic areas where access coverage is available via the access network 110, the complexity involved in obtaining network access on an ad-hoc basis makes access infeasible in certain cases. For example, access to cellular/mobile networks is typically limited to subscribers of a certain network operations provider. This is often done via the use of a subscriber identity module (SIM). The use of the SIM can lead to denial of communication services through certain access networks.

Various factors, such as the limited availability of radio spectrum, signal to noise issues, and transmission power issues, sometimes impose limits on the capacity of a physical channel in the access network 110 to carry traffic. Equipment limitations (such as limited processing capability) can also lead to limitations in routing and processing data packets through the access network 110. As for cost aspects, the access network 110 can be inherently high in cost due to a variety of factors, such as associated with the extensive wireline and/or wireless (last mile) infrastructure required to reach subscribers. High costs can also be attributed to operations, administration, maintenance, and provisioning (OAMP) associated with the access network 110.

In summary, it would be desirable to address at least some of the various shortcomings and deficiencies described above with respect to the traditional packet communications network.

### SUMMARY

According to the various embodiments of the present disclosure, network control can be extended to user elements and terminal elements, in addition to the control extended to intermediate network elements.

In a first aspect of the disclosure, a client access manager module is described, the client access manager module comprising: a network interfaces module connected to a plurality of access networks; the client access manager module which: is a part of a user element or terminal element of the plurality of access networks; aggregates the plurality of access networks into a virtual network; and receives and interprets network information from a network controller.

In a second aspect of the disclosure, a communications system is disclosed, the system comprising: a user element loaded with the client access manager module of the first aspect; a plurality of network elements networked with the user element via a plurality of access networks; a network controller controlling the plurality of network elements and communicating network information to the user element; a gateway connected to the plurality of network elements, the gateway configured to route control data from the controller to the user element; and a terminal element networked to plurality of network elements via the gateway, wherein communication between the user element and the terminal element is provided by virtual transmission links on the virtual network.

Further aspects can be discerned from the disclosure provided herein.

### BRIEF DESCRIPTION OF DRAWINGS

Many aspects of the invention can be better understood with reference to the following drawings. The drawings, which are incorporated into and constitute a part of this specification, illustrate one or more embodiments of the present disclosure and, together with the description of example embodiments, serve to explain the principles and implementations of the disclosure. The components in the drawings are not necessarily to scale. Instead, emphasis is placed upon clearly illustrating the principles of the invention. Moreover, in the drawings, like reference numerals designate corresponding parts throughout the several views.

FIG. 1 shows a prior art communications system.

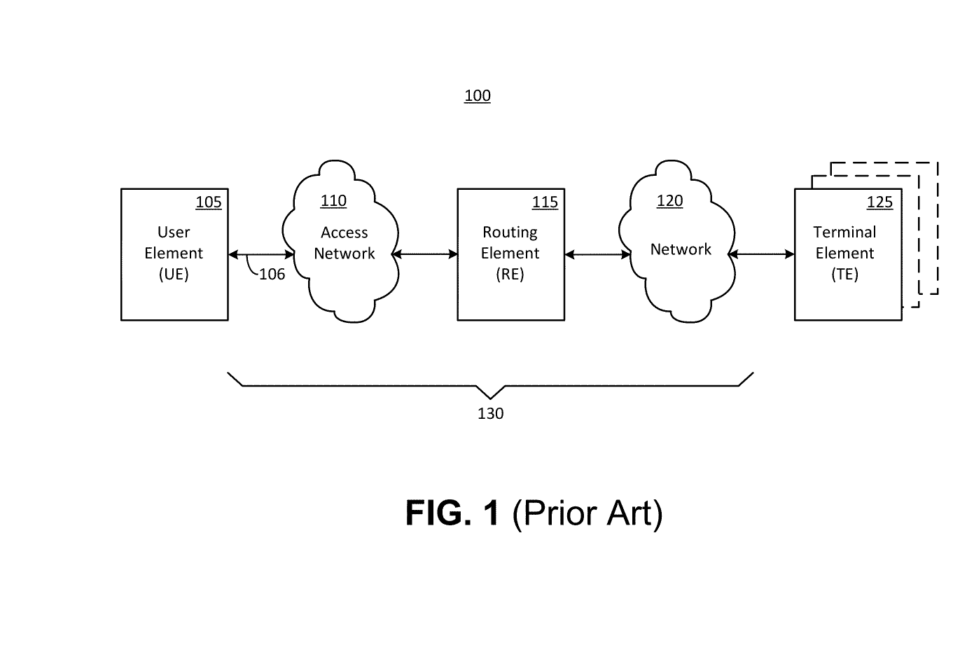

FIG. 2 shows a few exemplary functional aspects of the communications system in accordance with the disclosure.

FIG. 3 shows a first exemplary communications system in accordance with the disclosure.

FIG. 4 shows a few exemplary function modules that can be included in a client asset management module of a client device in accordance with the disclosure.

FIG. 5 shows an exemplary embodiment wherein user equipment is communicatively coupled to a gateway via a virtual access network in accordance with the disclosure.

FIG. 6 shows an exemplary traffic flow in a frontend access path segment between a user equipment and a gateway in accordance with the disclosure

FIG. 7 shows a second exemplary embodiment of a communications system in accordance with the disclosure.

FIG. 8 shows an exemplary format to implement an encapsulation procedure in accordance with the disclosure.

FIG. 9 shows some exemplary aspects pertaining to encapsulation encoding and structure in accordance with the disclosure.

FIG. 10 shows a second exemplary communications system incorporating an integrated virtual device in accordance with the disclosure.

FIG. 11 shows a third exemplary communications system wherein user equipment is configured as a replaceable heterogeneous device.

FIG. 12 shows a fourth exemplary communications system wherein metadata annotation is extended to certain portions of an end-to-end data packet path.

FIG. 13 shows an exemplary computing element for executing various functionalities in accordance with the disclosure.

### DETAILED DESCRIPTION

Throughout this description, embodiments and variations are described for the purpose of illustrating uses and implementations of inventive concepts. The illustrative description should be understood as presenting examples of inventive concepts, rather than as limiting the scope of the concept as disclosed herein. It should be further understood that certain words and terms are used herein solely for convenience and such words and terms should be interpreted as referring to various objects that are generally understood by persons of ordinary skill in the art. For example, words such as “server,” “gateway,” and “client” have been used herein in the context of packet based communications networks. However, these words must be interpreted in a broad sense so as to encompass various other types of communication networks wherein the systems and methods in accordance with this disclosure can be applied. The word “example” as used herein is intended to be non-exclusionary and non-limiting in nature. More particularly, the word “exemplary” as used herein indicates one among several examples, and it must be understood that no extraordinary emphasis or preference is being directed to the particular example being described. Furthermore, it should be understood that systems and methods in accordance with the disclosure are implementable in a variety of ways that, separately or in combination, can combine hardware in various forms with software, firmware, or other forms of computer-implementable code stored in a computer-readable storage medium.

Turning now to a general description of the disclosure, the various example embodiments described herein are generally directed to systems and methods for providing enhanced network connectivity in a packet data communications network. Towards this end, a general overview of packet data communications networks and related topics will be presented first followed by a few exemplary embodiments in accordance with the disclosure. It must be understood that the systems and methods in accordance with the disclosure can be applied to the various packet data communication networks, procedures, and technologies that are described below.

Packet data communications networks are typically represented in the form of a graph having several nodes that are interconnected to each other via lines that are referred to as edges. Each node represents a network element (NE) and each edge represents a transmission link, such as a wireless transmission link or a wireline transmission link. Each NE can be further referred to by various other terms, such as user equipment (UE) or terminal equipment (TE), which describes the use of the particular NE as a terminus of the given network (although not necessarily an ultimate terminus of all networks). The edges can be characterized by physical ports on various NEs and wired or wireless transmission apparatus. A physical transmission link can host one or more virtual transmission links. The virtual transmission links are constructed via software, and several of these virtual transmission links can be configured to operate as a virtual network (VN).

A VN can be used to partition a physical network into multiple separate logical networks. A VN can also be constructed as the union of multiple separate physical networks, in which case any differences that might exist between the multiple separate physical networks can be reconciled in order to form the VN. The VN concept can be used to load-balance traffic and maintain connectivity in response to physical link congestion and failures, and to provide connection optimization and congestion control.

Various types of devices can be coupled to a packet data communication network. In certain scenarios one or more of these devices can be particularly referred to as a UE or a TE in accordance with a functionality associated with the respective device. As used herein, UEs refer to devices trying to access a service on the network and TEs refer to devices providing a service for UEs. Typically, UEs include devices like smart phone handsets, tablet computers, wearable networked devices, laptop and desktop computers, set-top entertainment boxes and game consoles, vending machines, consumer and industrial robots, environmental sensors, Internet connected vehicles, and the like; or a server connected by a local network to such a device which, from the non-local network perspective, appears as being the UE. Typically, TEs include devices like server computers, network storage elements, and clusters of such devices. However, situations can be envisioned where a typically UE device is performing as a TE or a typically TE device is performing as a UE. Additionally, the UE and TE can be connected through a virtual private network (VPN).

Communication between two NEs can take place as a point-to-point communication session or as a point-to-multipoint communication session. Each communication session can use a single data packet or a number of data packets that are structured in various ways. The present disclosure generally describes methods and systems with reference to a point-to-point session between a UE and a TE. However, it must be understood that these methods and systems are equally applicable to point-to-multipoint communication sessions as well, such as a UE communicating with multiple TEs.

Terms such as routing element (RE), router, gateway, or switch can be used to refer to NEs whose primary function is to steer traffic through a packet data communications network. Typically each of these NEs is connected to other elements via more than one transmission link. However, in some cases two NEs can be interconnected by a single link.

An NE can be sometimes referred to as a processing element (PE) when the NE functions to transform, monitor, store, respond to or otherwise process packets that flow through the NE. Many NEs perform a mixture of routing and processing functions, and so a NE can be referred to as both an RE and a PE in some instances. A gateway element (GE) can also be distinguished as a special class of NEs. A GE can mediate traffic between two or more logically separate packet data networks.

Packet data communications networks can be configured to propagate data packets over various physical transmission media using various types of signals, such as voltage based signals, current based signals, optical based signals, radio based signals, audio signals and so on. The equipment that transmits, receives, modulates and demodulates these signals constitutes the physical layer (layer 1) of a packet data communications network. The methods of the present disclosure can be used with different types of physical layers.

The Ethernet protocol, as defined by IEEE standards, is a prominent data link layer (layer 2) protocol that enables the selection of corresponding NEs and provides transmission framing and error checking. Layer 2 protocols identify NEs by means of binary addresses (media access control (MAC) addresses). These data link layer addresses are not typically propagated outside local area network (LAN) domains.

The internet protocols (IP), as defined by the IETF IPv4, IPv6 and IPSec standards are the dominant network layer (layer 3) protocols responsible for packet forwarding within wide area networks (WANs). The methods and systems in accordance with the disclosure can be applied to one or more of such internet protocols. Transport protocols such as TCP and UDP (defined by IETF standards and recommendations) and variants are currently the most common transport (layer 4) protocols employed in IP packet networks. These protocols provide end-to-end (correspondent-to-correspondent) data flow service. The methods and systems in accordance with the disclosure can be applied to one or more of such transport protocols as well.

Two or more TEs of a point-to-point or multi-point communication system are typically identified by layer 2 (MAC) addresses and layer 3 (IP) addresses. The UDP and TCP protocols provide an individual identifier referred to as a port number, which can be used to select a component end-point for the communication within a TE or PE. Typically this component is implemented as software logic (application) within the addressed element. These port numbers might or might not be visible to intermediate NEs.

The forwarding function of layer 2 and layer 3 protocols can be performed using forwarding tables and associated logic embedded in REs. The configuration and maintenance of these forwarding tables is directed and informed by various standard and proprietary control protocols. This functionality can be referred to as the control plane, in contrast to the data plane of a packet network.

The quality of service (QoS) of an end-to-end data flow service includes a number of aspects such as speed (bandwidth), delay (latency) and reliability (error rate). The QoS of an end-to-end service can be characterized by a complex interaction of transmission errors, link congestion, control layer forwarding and drop rules applied by NEs, intervention of specific traffic shaping NEs, and the buffering and processing capacity of NEs and TEs.

A recent concept in networking technologies, popularly known as software defined networking (SDN) has emerged to improve on certain prior art shortcomings, such as for example, reducing the complexity of state-of-the-art REs. Currently REs employ complex suites of control layer protocols to perform autonomous packet forwarding and QoS functions. SDN exposes the hitherto closed RE data structures and logic at a remote interface, thus enabling external apparatus here referred to as a control element (CE) to dynamically inspect and load these forwarding tables and logic. OpenFlow, specified by the Open Networking Foundation (ONF), currently is a prominent instance of the SDN concept applied to layer 2 and 3 packet forwarding. As is known, OpenFlow is an open interface for remotely controlling the forwarding tables in network switches, routers, and access points. Upon this low-level primitive, researchers can build networks with new high-level properties.

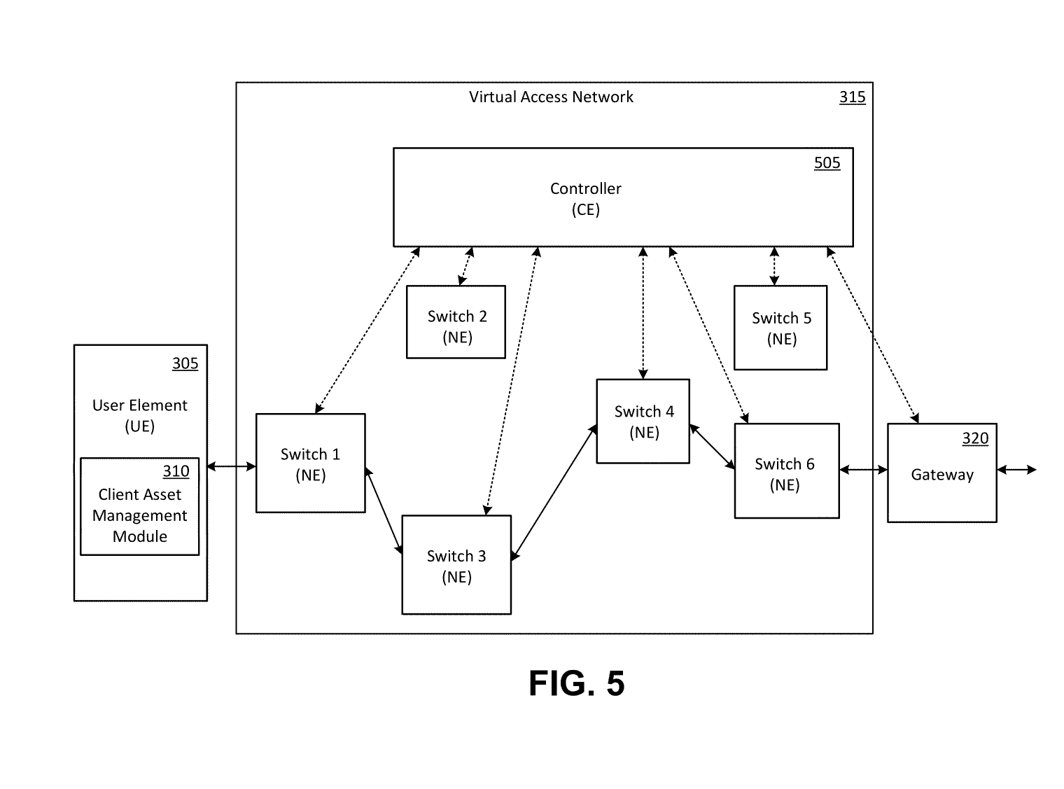

An SDN packet network typically incorporates two separate graphs that are interconnected. The first graph pertains to a data plane that represents data packet flows among corresponding TEs. The second graph pertains to a control plane that represents meta-data about data plane traffic and control data that can be used to configure NE functionalities. The control plane can include specialized NEs that can be referred to as control elements (CE). An exemplary SDN structure is described below with respect to FIG. 5.

Another recent concept in networking technologies is popularly known as network functions virtualization (NFV). NFV has emerged to guide the transition of network operators from traditional infrastructure to infrastructure incorporating SDN networks and low cost commodity apparatus. In this context it might be relevant to view SDN networks as enabling virtual networks (VN) that operate under SDN control plane programming to steer traffic to virtual servers (VS) that are spun up and spun down according to demand. The aim is to achieve lower cost, lower power consumption, lower complexity than existing infrastructure that is built with dedicated network (NEs) and processing elements (PEs).

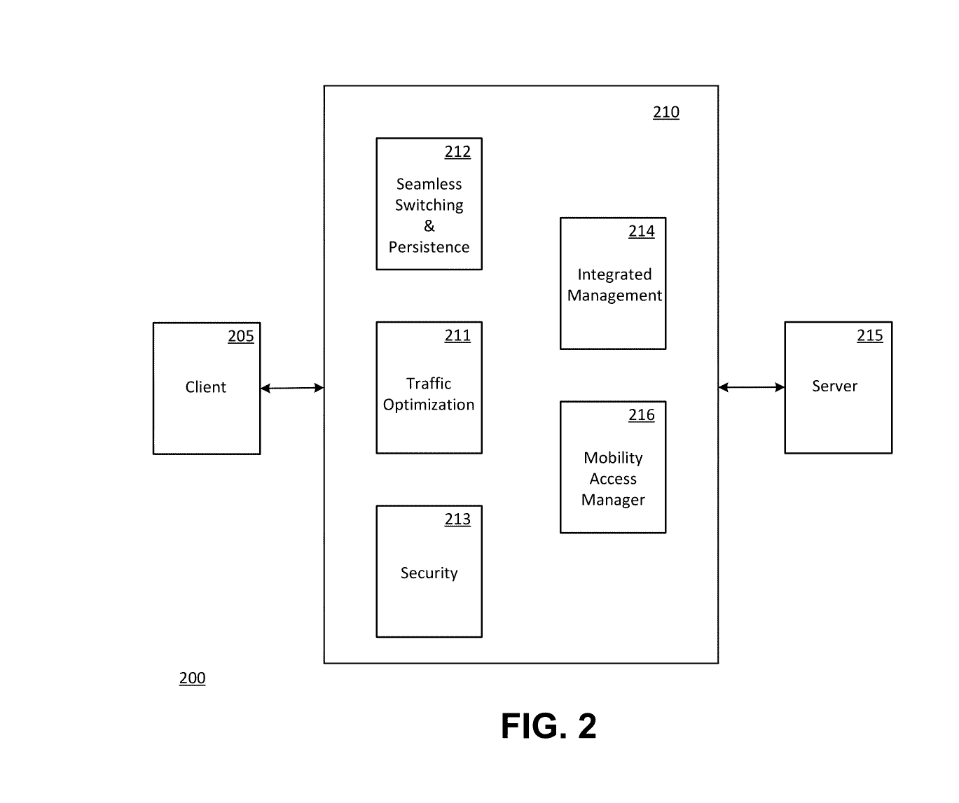

Attention is now drawn to FIG. 2, which shows a few exemplary functional aspects of communications system 200 incorporating a packet data communications network 210 in accordance with the disclosure. As shown, the packet data communications network 210 includes a few exemplary functional aspects. These exemplary functional aspects can be effectuated when providing communications interconnectivity between one or more user elements, such as a client 205, and one or more terminal elements, such as a server 215. It must be understood that in addition to the few exemplary functional aspects shown in FIG. 2, the packet data communications network 210 can incorporate several other advantageous functionalities and features in accordance with the disclosure.

In general, the various functional aspects that are shown with respect to the packet data communications network 210 can be used to address various handicaps associated with traditional packet data communications networks. The client 205 can be operated by an end-user (a subscriber, for example) to access communications, content and services hosted on the packet data communications network 210, which can be a public network such as the Internet and/or a private network via service provider data-centers (cloud storage) for example. Server 215 can communicate with other servers (not shown) via the packet data communications network 210 by using machine-to-machine (M2M) functions for example.

The traffic optimization block 211 pertains to certain procedures in accordance with the disclosure that are described below in more detail using other figures. In short, such procedures can include for example, end-to-end lossless streaming compression in real time (both upstream and downstream) that can improve the transmission speed of data packets through the packet data communications network 210.

The seamless switching and session persistence block 212 pertains to certain procedures in accordance with the disclosure that are described below in more detail using other figures. In short, such procedures can include, for example, a procedure for directing data packets seamlessly and with session persistence over a best available network. The best available network, which can be determined by an operator in some embodiments, can speed up data packet transfers in various ways. For example, downloads and uploads can be configured to continue precisely where left off during an interruption of service so as to avoid redundant data packet transmission. As another example, a backup tunnel connection can be provided in situations where more than one network is available for use.

The security block 213 pertains to certain procedures in accordance with the disclosure that are described below in more detail using other figures. In short, such procedures can include for example, a procedure for creating a VPN and another for creating a permanent secure tunnel between the server 215 and the client 205.

The integrated management block 214 pertains to certain procedures in accordance with the disclosure that are described below in more detail using other figures. In short, such procedures can include for example, integrating various management functions that are traditionally executed on multiple devices at multiple times and in multiple ways can be executed in as few as a single device, thereby allowing a single operator to perform various operations that are applicable to various devices.

The mobility access block 216 pertains to certain procedures in accordance with the disclosure. Such procedures can include for example, storing, managing, and/or retrieving customer related data (license, certificates, etc.); creating/configuring various settings of one or more servers, client groups, clients, access points, software packages for auto updates, etc.; providing web services to configure servers and clients remotely; providing different ways of authentication, authorization and accounting for incoming client connections, using different users databases (local, remote); and/or allowing automatic configuration of clients in case an already authenticated connection is re-established.

The server 215 can execute various functions, such as for example, accepting connections from one or more clients (such as client 205), handling compressed/encrypted data traffic, directing data traffic to other clients or to another internet/intranet, and/or handling session persistence for each individual client. The server 215 can use a virtual Ethernet adapter and an IP address range to create secure and compressed traffic inside of a subnet. The server 215 can act as an interface between a billing client for example and a range of other systems in a billing system. The server 215 can further handle prediction analysis for microarrays (PAM) in order to, for example, authenticate some data flows, access a domain name system (DNS) for name resolving, execute network address translation (NAT) related operations, execute simple network management protocol (SNMP) related operations, execute world wide web (WWW) server related operations, execute file transfer protocol (FTP) related operations, and execute firewall functionality.

The client 205 can execute various functions such as: handling available physical interfaces to create connection through any type of network (wireless, wired, satellite, etc.), handling network connection to the server 215 through all available network interfaces and across all IP based traffic layers, executing seamless switching across all available traffic layers, controlling a tunnel to make application layer connections persistent, compressed and encrypted, using remote and local storage to authenticate connections transparently, activating and closing remote access service (RAS) (GPRS, 3G, etc. connections) interfaces automatically, and/or maintaining online application sessions and data transfer sessions alive during network interrupts (i.e. seemless switching with session persistence) and immediately establishing connection to the server 215 once a traffic layer becomes available.

In summary, the communications system 200 provides various advantageous features in accordance with the disclosure. Specifically, these features can include maintaining various sessions across temporary loss of connectivity; aggregating multiple access networks into a single virtual access network (VAN) thereby making network handovers across bearers and providers automatic and invisible to network layers 3 and above; improving the utilization of links by eliminating re-transmissions, avoiding under- and over-shoot of capacity, shifting traffic to alternate links and time-shifting traffic from high- to low-demand periods; enabling the spreading of transmission load across multiple links more simply and efficiently according to demand; enabling the spreading of routing and processing load to any number of physical and virtual machine NE whereby one or more NEs can be initialized, incorporated and removed from the network dynamically according to demand; reducing the complexity and required capacity of the control plane hardware, thus reducing capital cost; and/or reducing the electrical power consumption by enabling the power-down of one or network links and elements when demand is low. These aspects can be further understood in view of the description provided below.

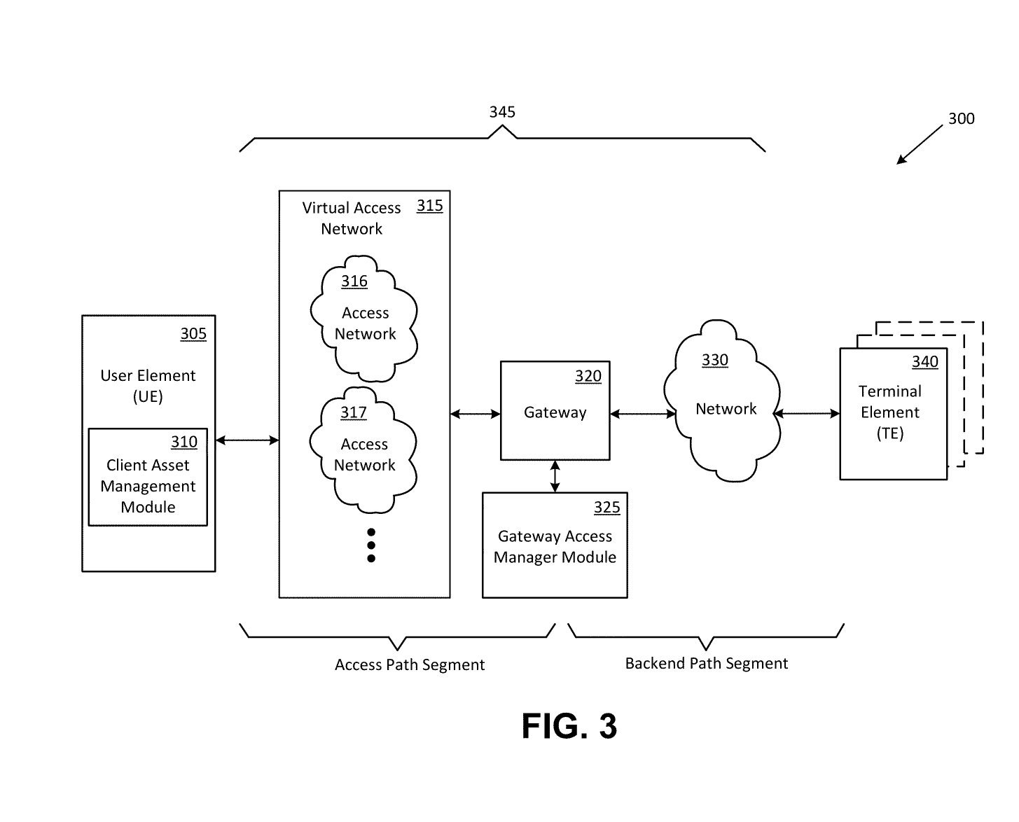

Attention is now drawn to FIG. 3, which shows a first exemplary embodiment of a communications system 300 in accordance with the disclosure. In general terms, communications system 300 includes a packet data communications network 345 that provides communications interconnectivity between one or more clients and one or more servers. In this particular exemplary embodiment, the one or more clients are represented by a user element (UE) 305 and the one or more servers are represented by a terminal element (TE) 340. The packet data communications network 345 includes a virtual access network 315, a gateway 320, an access manager 325, and a network 330 that can be a WAN in certain implementations.

Attention is drawn to the client access management module 310 located in the UE 305. The client access management module 310 can be used by the UE 305 to create a virtual access network 315 by aggregating two or more of access networks that are available for communicative coupling to the UE 305. Attention is also drawn to the gateway access manager module 325 that is communicatively coupled to the gateway 320. Though the client access management module 310 is shown located inside the UE 305 and the gateway access manager module 325 is shown communicatively coupled to the gateway 320, in various embodiments, some or all components of the client access management module 310 can be located outside the UE 305 and some or all parts of the gateway access manager module 325 can be located inside the gateway 320. Furthermore, each of the client access management module 310 and the gateway access manager module 325 can be implemented using hardware, software, firmware and/or a combination thereof. Some of these elements associated with the client access management module 310 and the gateway access manager module 325 are described below using other figures. However, some aspects pertaining to the operations and characteristics of the client access management module 310 and the gateway access manager module 325 will now be described.

The end-to-end path between the UE 305 and the TE 340 can be interpreted as constituting two segments—an access path segment and a backend path segment. The access path segment lies between the UE 305 and the gateway 320, while the backend path segment lies between the gateway 320 and the TE 340. The partitioning of the end-to-end path into the two segments advantageously enables independent selection of traffic bearer and control regimes appropriate for the different characteristics of the two different segments.

In some embodiments, data packets transmitted in either direction in the access path segment (between the UE 305 and the gateway 320) can be encapsulated within IP packet envelopes and data packets can be transmitted without encapsulation in either direction in the backend path segment (between the gateway 320 and the TE 340). However, in certain other embodiments, data packets can be encapsulated and transmitted in either direction in the backend path segment (between the gateway 320 and the TE 340) as well. For example, encapsulation can be advantageously used when the data packets are transmitted via an expensive path (such as one that includes an inter-continental gateway) in order to derive various benefits associated with using data compression and metadata formats. Encapsulation can be also advantageously used to preserve the metadata carried by the envelopes when SDN is employed in the backend path segment. The encapsulation format can be extended to the TE 340 in order to obtain various benefits associated with metadata, compression, and optimization techniques. The TE 340 can be suitably configured by a service provider of the TE 340.

Since the gateway 320 presents a static IP address towards the TE 340 and routes to temporary IP addresses as the UE 305 moves, there are no session breaks between the TE 340 and the UE 305, thereby creating seamless switching with session persistence.

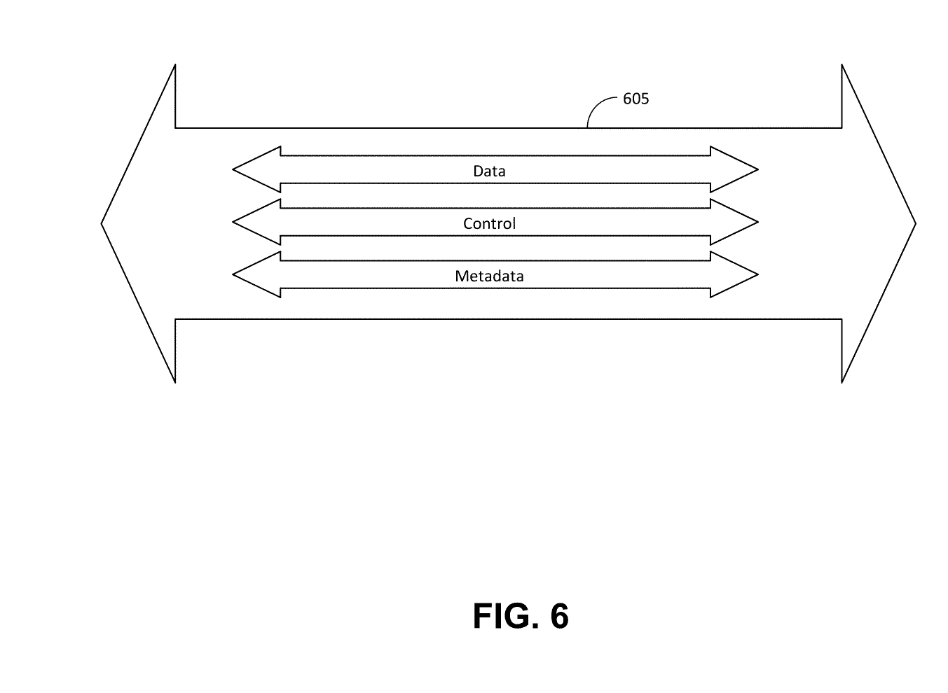

Some broad aspects of the UE 305 and the gateway 320, with reference to the client access management module 310 and the gateway access manager module 325, will now be described. The UE 305 typically provides an execution environment (using various modules that are described below in more detail using FIG. 6) for a number of processes that communicate via a network stack component of an operating system (OS).

In some embodiments, a traditional OS that is present in a prior art UE can be replaced by the client access management module (CAMM) 310, or modified in accordance with the CAMM 310. In one embodiment, the CAMM 310 can be implemented as a module that executes commands in a secure address space with privileged access to operating system services. The CAMM 310 can be digitally signed and verified, or similarly protected from unauthorized alteration. In another embodiment, the CAMM 310 can be implemented as a service running as a user application that provides information to the operating system which, in turn, commands the operating system services.

The client access management module 310 can be used to apply certain rules and operations upon incoming as well as outgoing data packets. For example, client access management module 310 can be used to match one or more outgoing data packets against a set of processing rules that determine the succeeding processing steps that are applied to the matched one or more data packets. The steps to be applied can be marked as a vector of processing (action) requests associated with the matched one or more data packets. In some implementations, the processing rules can take the form of condition-action rules, such as those employed by OPSS production systems, forward chaining expert systems, and the OpenFlow SDN rules.

The client access management module 310 can be further used to execute one or more of the following exemplary actions.

Forward: A forwarding action can request that a data packet be forwarded using specifically nominated or types of network interface(s), or to a specified gateway (in the case that the UE 305 is served by multiple gateways), or not transmitted at all (dropped). These actions correspond to what is known in the art as “control plane” actions performed by a routing element (RE). Such actions can be expressed in a language such as OpenFlow.

Annotate: The outgoing data packets can be encapsulated in IP envelopes. The IP envelopes can be formatted to carry metadata associated with the data packets carried within the IP envelope. The annotate action can be used to specify various values associated with the metadata.

Compress: The data packets can be compressed using a nominated algorithm. In some embodiments, a stream compression algorithm can be applied when the packet is a member of a sequential flow.

Encrypt: The data packets can be encrypted in order to ensure privacy of communications between the UE 305 and gateway 320. Private and/or public key encryption methods can be used to, for example, provide VPN connectivity.

Priority: One or more data packets can be assigned a priority, such that higher priority data packets can pre-empt lower priority data packets through the processing pipeline and outgoing transmit logic.

Shape: The data packets can be assigned a bandwidth constraint class to limit the proportion of available outgoing bandwidth allocated to data packets of that class. This can be done for example when the total available bandwidth of an input/output interface of the UE 305 is limited.

As indicated above, the processing of data packets can be directed by a set of processing rules. These processing rules are, in some embodiments, loaded in response to a control request from the gateway 320. In some instances, the gateway 320 can be relaying some or all of these rules from one or more network controller elements (not shown).

The gateway 320 can include a processing pipeline (not shown) that is complementary in various functions executed by the client access management module 310. Rules and certain operational aspects of the processing pipeline can be specified as part of an installation procedure for the gateway 320 and/or dynamically provided by one or more other network control elements. The processing pipeline can be particularly configured as a data plane processing pipeline.

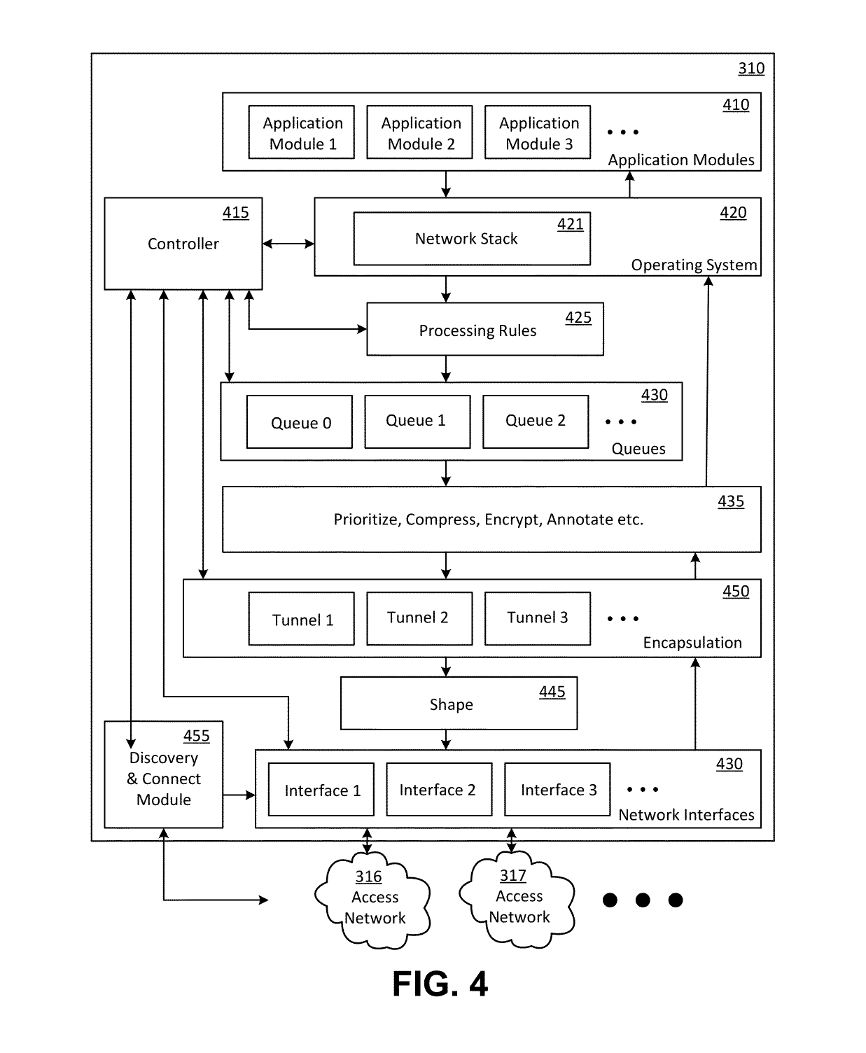

Attention is now drawn to FIG. 4, which shows a few exemplary function modules that can be included in the client asset management module 310 associated with the UE 305 in accordance with the disclosure. These function modules can be implemented in hardware, software, firmware or a combination thereof. The functionality of some of these function modules are self-evident in view of the various actions of the client access management module 310 that are described above. Consequently, these modules will not be described herein in detail.

For example, the applications module 410 represents various executables that can be used to execute a variety of functions based on interaction with modules such as the processing rules module 425. The operating system 420 can be used to execute a stack functionality via the network stack 421, and the processing rules module 425 can be used to enforce certain networking rules (for example, to drop one or more specified data packets) and to provide various processing rules to other modules. The queues module 430 can be used to process multiple queues that are received from and transmitted to, the priority, compress, encrypt, and annotate module 435. A network stack typically consists of a network protocol stack, a programming interface (API), and a network interface hardware driver. The network protocol stack consists of a layered set of modules, wherein each module implements a network protocol.

The functionality of the priority, compress, encrypt, and annotate (PCEA) module 435, the encapsulating module 450 and the shape module 445 can be understood in view of corresponding actions that are described above. The PCEA module 435 associates annotations with ranges of transmitted and received data. These annotations can convey information such as meta-data or processing instructions to be applied to the associated data. The encapsulation module 450 provides framing and formatting that allows these annotations to be visible to the network elements that examine the packets along transmission paths. The discovery and connect module 455 can be operated under control of the controller module 415. The discovery and connect module 455 can be used to implement certain exemplary functions such as access point discovery and power conservation.

FIG. 3 is used in conjunction with FIG. 4 to elaborate upon access point discovery. The discovery and connect module 455 can be used to communicatively interact with various network elements, including network elements that are a part of access network 316 and/or access network 317. In some exemplary implementations, access network 316 can be similar to access network 317. For example, both access networks can be wireline networks. However, in some other exemplary implementations, access network 316 can be different than access network 317. For example, access network 316 can be an optical network and access network 317 can be a radio network. The discovery and connect module 455 establishes connectivity between the UE 305 an appropriate access network on the basis of various criteria, some of which are described above with respect to FIG. 2.

Some of the network elements of the various access networks such as one or both of access network 316 and access network 317 can include non-advertising network elements. Consequently, the discovery and connect module 455 can use probing procedures for access point discovery, while other network elements can be advertising network elements that are monitored by the discovery and connect module 455. The discovery and connect module 455 can be used to specifically probe certain network elements located in the proximity of the UE 305. The location of these network elements that can operate as access points can be provided to the UE 305 by the gateway access manager module 325, via the gateway 320 (by using a control channel for example).

The discovery and connect module 455 can also be used for power conservation purposes. For example, in some implementations, the client access manager module 310 can offload certain processing operations to a cloud service. When this is done, the discovery and connect module 455 can be configured to automatically power down one or more of the interfaces in the network interfaces module 430. This action can advantageously address a typical situation wherein smartphone users often leave Wi-Fi interfaces active even when there is no need for using the Internet.

The controller module 415 can be used for executing a variety of OAMP functions. In various embodiments, the controller module 415 can be used to manage the network interfaces 430 such as, for example, operations associated with bandwidth capacity estimates and constraints, latency estimates, monetary cost estimates and power consumption estimates. The controller module 415 can also be used in cooperation with other modules for example to interpret policy rules for providing a desired quality-of-service and power consumption for one or more currently queued outgoing packets and one or more currently queued incoming packets. The policy rules can be executed in response to a control request from the gateway 320. One or more connection policies can be loaded from the gateway 320 via the control channel or can be specified via a subscriber interface (not shown).

The controller module 415 can be further used to maintain and control metadata channels including handling of requests from the gateway 320. Such requests can incorporate processing rules, connection management rules, access point parameters and metadata requests.

The discovery and connect module 455 can be used to manage a plurality of available network interfaces. Available network interfaces can be considered as different channels of communication. For example, a network interface can be a nearby wireless network, a fiber optic connection, and/or a satellite link. Management of the available interfaces, which can be carried out on the basis of a priority scheme, allows for seamless switching of data packets. Consequently, a subscriber can freely roam between different types of networks and carriers while the client access management module 310 selects the best interface and switches to this interface. All data from existing and new connections can be sent through that interface. Priority of the available interface can be adjusted manually or can be controlled by the gateway 320.

A network interface can be placed in a locked condition. This option provides data transfer only through the locked interface. As soon as an available interface is locked, the discovery and connect module 455 can be configured to stop attempting to switch to a different interface. An interface can be disabled. This option disables interface and excludes it from the list of interfaces being used. An interface can be used for backup. When turned on, this option allows using an interface as a reserve connection in case the current connection is lost. The backup connections always try to stay alive when available but are in standby mode. An interface can be hidden. When turned on, this option allows removal of a disabled interface from the interface list.

In some embodiments, the client access management module 310 can provide for management of one or more SIM cards thereby offering mobility functionalities. Some SIM related operations include managing SIM PIN/PUK code, scanning for mobile networks, providing mobile network operator (MNO) names, providing a selection choice amongst MNOs to a subscriber, providing information pertaining to network quality, providing short messaging services (SMS) management functionality including SMS sending, SMS receiving, SMS creation, SMS deletion, SMS forwarding, and SMS replying.

In some embodiments, the client access management module 310 allows for easy management of various wireless connections such as, for example, selecting of a particular WLAN profile when establishing a connection. In some implementations, the selecting procedure can be offered as a manual feature, while in other implementations, the selecting procedure can be automated.

FIG. 5 shows an exemplary embodiment wherein the UE 305 is communicatively coupled to the gateway 320 via the virtual access network 315 in accordance with the disclosure. Various network elements of the virtual access network 315 can be configured by one or more network controllers such as the controller 505 in order to provide connectivity between the UE 305 and the gateway 320. In some exemplary implementations, the controller 505 can configure the data plane associated with the various NEs via an OpenFlow switch (agent). In this context, several control paths are indicated by dashed lines. The packet flow paths are indicted by solid lines interconnecting the various function blocks.

The controller 505 is interactively coupled to the gateway 320 so as to directly control the gateway 320 via controls and commands, and to indirectly control the UE 305 via the gateway 320. The controller 505 can communicate with the UE 305 via the gateway 320. The gateway 320 can relay the communication from the controller 505 to the UE 305 by employing a control protocol encapsulation as illustrated in FIG. 6. The UE 305, in turn, can address replies to the controller 505 via the gateway 320 by the reverse of the above procedure.

Alternatively, the controller 505 can choose to implement an alternative method to communicate with the UE 305, wherein the gateway 320 keeps the controller 505 informed of the current network address of the UE 305. Employing this method, the controller and UE can communicate directly employing the network address provided by, and periodically updated by, the gateway. This direct communication method, however, adds complexity to the controller in maintaining the connectivity and dealing with handovers and errors.

The gateway 320 can implement a control protocol interface and agent, such as OpenFlow, to enable programmatic control of the gateway 320 itself. The gateway 320 can also implement an interface that forward control protocols to the UE 305. The UE 305 can incorporate a corresponding agent, such as an OpenFlow switch. The control protocol can be transmitted using a control channel embedded in the encapsulation protocol. This aspect is described below in more detail using FIG. 6.

In one exemplary implementation, an SDN control regime can be used upon the front end path segment (between the gateway 320 and the UE 305). The backend path segment (between the gateway 320 and the TE 340 as shown in FIG. 3) can be configured in a manner analogous to the access path segment. In this one exemplary implementation, the gateway 320 can mediate a control channel between the TE 340 and one or more NEs in the virtual access network 315.

In this exemplary embodiment, the gateway 320 includes the gateway access manager module 325. The gateway access manager module 325 keeps the UE 305, as well as other connected UEs (not shown), updated with information such as access point locations, login credentials, connection policies and other parameters required to perform the network discovery and connection manager functions by the client access management module 310. In some embodiments, the gateway 320 can request the client access management module 310 to provide information such as location metadata and forwards parameter requests to one or more NEs that are located geographically close to the UE 305.

The controller module 415 that is a part of the client access management module 310 can maintain information pertaining to various control and metadata channels, and can interpret and execute control and metadata requests issued by the gateway access manager module 325. The repertoire of requests can include, for example, processing rules, connection management rules, access point parameters and metadata requests.

FIG. 6 shows an exemplary traffic flow 605 in the frontend access path segment between the UE 305 and the gateway 320 in accordance with the disclosure. Traffic flow 605 includes end-to-end data plane traffic between the UE 305 and the TE 340, and control plane traffic between the UE 305 and one or more controllers located in NEs between the UE 305 and the gateway 320. These NEs can be mediated by the gateway 320. In some exemplary embodiments, the control traffic can be given a higher priority than the data plane traffic.

The traffic flow 605 can also include metadata provided by the UE 305 to the gateway 320 and metadata related requests from the gateway 320 to the UE 305. The UE originated metadata can include, for example, direct sensory readings, such as geo-location, device motion, temperature, etc., as well as inferred parameters related to the UE 305, and/or environment and end-user behavior. Examples of such inferred parameters include: parameters inferred from motion sensors detecting end-user activity or predicted destination, such as when walking or driving a car; parameters inferred from audio sensors, such as loudness of environment; parameters inferred from radio sensors, such as with a crowd of people having Bluetooth and WiFi devices; and parameters inferred from a fusion of these and other sensors and of data stored on terminal equipment, such as determining that an end-user is engaging in sporting activity inferred from the combination of a calendar entry, motion sensors, heart rate monitor, and so on. This metadata can be utilized by the gateway 320 to present an application programming interface (API) for services that are aware of the state, situation, context, user behavior and other parameters available at the UE 305.

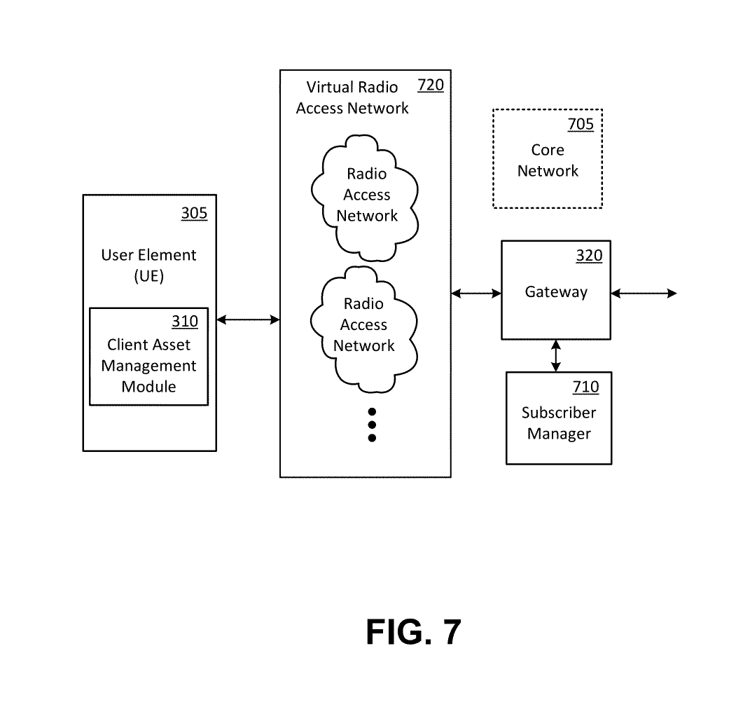

FIG. 7 shows a second exemplary embodiment of a communications system 700 in accordance with the disclosure. Attention is particularly drawn to the core network 705 that is a component of prior art networks, particularly one that is typically deployed by cellular wireless network operators. The core network 705 includes what is known in the art as an operator core network. The operator core network is generally a complex structure that is used for traffic steering, shaping, business processing and various service related functionalities.

The core network 705 is bypassed in accordance with the disclosure. Instead, the gateway 320 is provided with a subscriber manager 710. In some exemplary implementations, the subscriber manager 710 is an independent element that is communicatively coupled to the gateway 320 while in other exemplary implementations, the subscriber manager 710 can be integrated into the gateway 320.

In contrast to prior art practice where access networks employ various connection arrangements, home registers and associated complex signaling procedures to enable traffic processing and to maintain various parameter values, the subscriber manager 710 cooperatively operates with the gateway 320 to mediate traffic flows such as, for example, a traffic flow associated with a specific subscriber, and to maintain and process various connectivity parameters, such as subscriber parameters and policy parameters required to implement network connectivity. The information that can be used for providing these features can be stored and operate upon in one location (the gateway 320 for example) thereby providing various benefits.

The prior art core network 705 can be bypassed by suitably configuring one or more routing elements that might or might not be a part of the one or more routing elements (routers, switches etc.). In this exemplary embodiment, the UE 305 can be communicatively coupled to a virtual radio access network (RAN) 720 via the client access management module 310 of the UE 305 in accordance with the disclosure.

In some exemplary implementations, a unique gateway IP address can be assigned to each individual subscriber, such as an individual subscriber associated with the UE 305. Such an assignment, provides certain advantages such as, for example, address provisioning. Unassigned IP addresses can be routed to the gateway 320. The address assignment procedure also permits adding of virtual or physical servers to provide a desired capacity. The gateway 320 can independently process data flows from/to the subscriber associated with the UE 305 without interdependence on other gateways, or having to use high speed access to external control and business infrastructure. As a result the data flow to/from the subscriber experiences less delay in comparison to prior art data flows and the virtual access network 315 can be scaled more easily to meet variable subscriber demand.

The gateway 320 is preferably located within a short distance (short network delay) from the NEs (access points) used by a subscriber associated with the UE 305. In the case that the subscriber roams to another city, state or continent (long network delay) the gateway 320 can be relocated. The relocation of the gateway 320 can be carried out by notifying the UE 305 of a new gateway (not shown) having a different IP address, followed by provisioning the new gateway with information associated with the gateway 320. The handover from the gateway 320 to the new gateway can be affected using an incremental procedure so as to preserve ongoing transport layer sessions.

In cases where a persistent 1-to-1 or 1-to-N correspondence between subscribers and gateway IP addresses is undesirable for privacy, or other reasons, the IP addresses provided to the various subscribers can be periodically changed and/or multiple IP addresses can be used to transport end-to-end data traffic. The CAMM can have a MAC address assigned to it to facilitate dynamic IP routing.

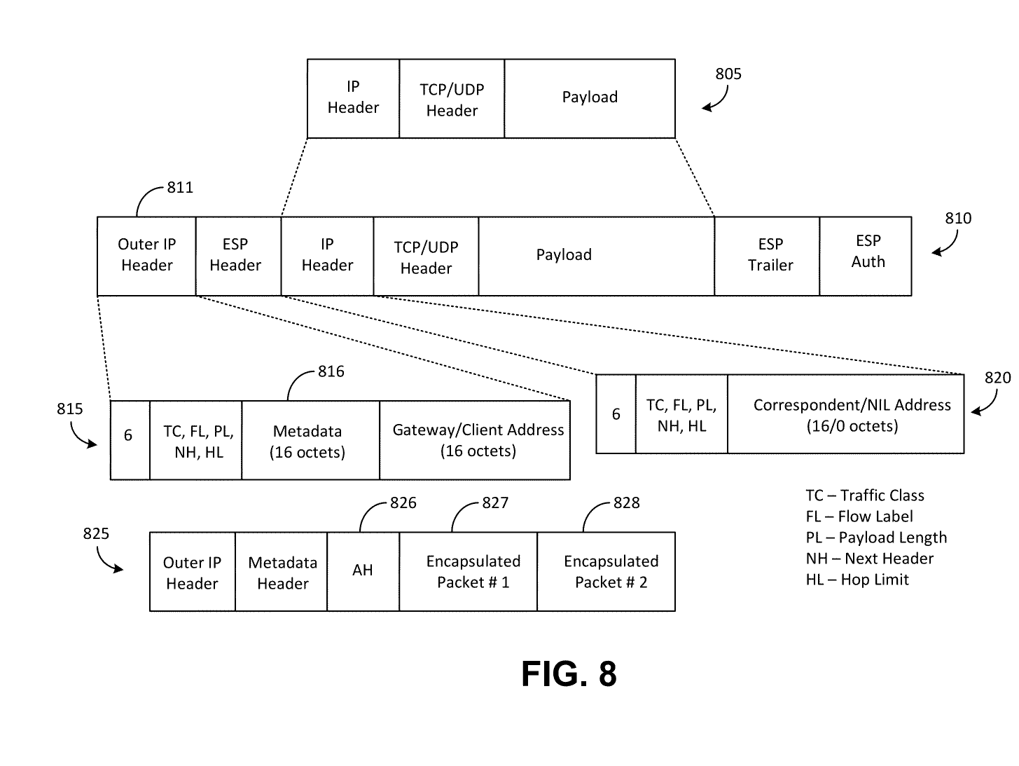

Attention is next drawn to FIG. 8, which shows an exemplary format to implement an encapsulation procedure in accordance with the disclosure. The encapsulation procedure allows for multiplexing a first channel formed of data plane traffic with a control channel and/or a metadata channel. Frame structure 805 refers to a prior art top level structure of an IP packet containing an IP header, a TCP/UDP header and a payload portion. Frame structure 810 is an adaptation of frame structure 805, in accordance with the disclosure. Frame structure 805 includes an outer IP header 811 formed of one or more IP packets that are encapsulated. Various industry standard formats (such as for example, IPSec tunnel mode structure) that generally preserve the destination address, inner headers and payload can be used when forming the frame structure 810.

Frame structure 810 can also include a metadata portion 816 that can carry encoding information in accordance with the disclosure. The metadata portion 816 can include metadata bit vectors that replace the source address within the prior art IP header envelope. Suitable pattern matching hardware and languages can be used for processing the metadata portion 816. Existing elements of the prior art network can be modified to accommodate these pattern matching hardware and languages.

Frame structure 825 shows a metadata header that can be used to supplement or to complement prior art IP standards. When the frame structure 825 is used, sufficient space can be further reserved to include a meta-metadata section that identifies the metadata vocabulary being used. The metadata encoding can be dynamically sized to carry the desired amount of information. Frame structure 825 can also carry an authentication header (AH) portion 826. Each of the data packet 827 and the data packet 828 can be encrypted for security purposes.

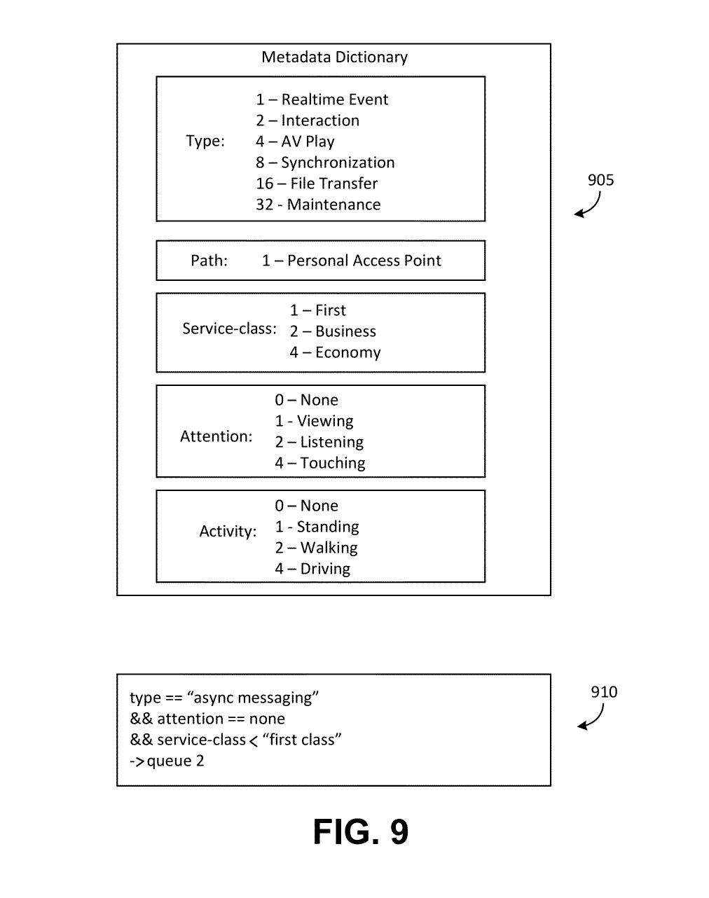

FIG. 9 shows some exemplary aspects pertaining to encapsulation encoding and structure in accordance with the disclosure. Block 905 is a metadata dictionary showing a few exemplary parameters that can be used to provide an encoded representation of metadata as well as context intention for the transmission of such metadata. For example, each of the “type” parameters refers to the type of data and the application that is transmitting the data; each of the “path” parameters refers to the network configuration of the UE 305; each of the “service-class” parameters refers to the subscribed service class; and each of the “attention” and “activity” parameters refers to the context of use.

Furthermore, each of the parameters can be encoded using a numeric encoding format as shown in block 905. The numeric encoding format enables a number of heterogeneous packets to be encapsulated into one envelope and can be described by using logical OR bit vectors. As an example, the “type” parameter can be made to require 6 bits to encode as a bit vector. The numeric encoding format can also be readily processed by pattern matching rules and dedicated logic circuits employed in high bandwidth routing elements such as routers.

In some embodiments, the semantics used for indicating various metadata related assertions enable scheduling, routing, and prioritizing of one or more data packets. These assertions can therefore be incorporated into rules and procedures of routing elements and/or NEs to determine forwarding and processing actions to be performed for each packet that carries the metadata. An exemplary implementation of such rules and procedures is shown in block 910.

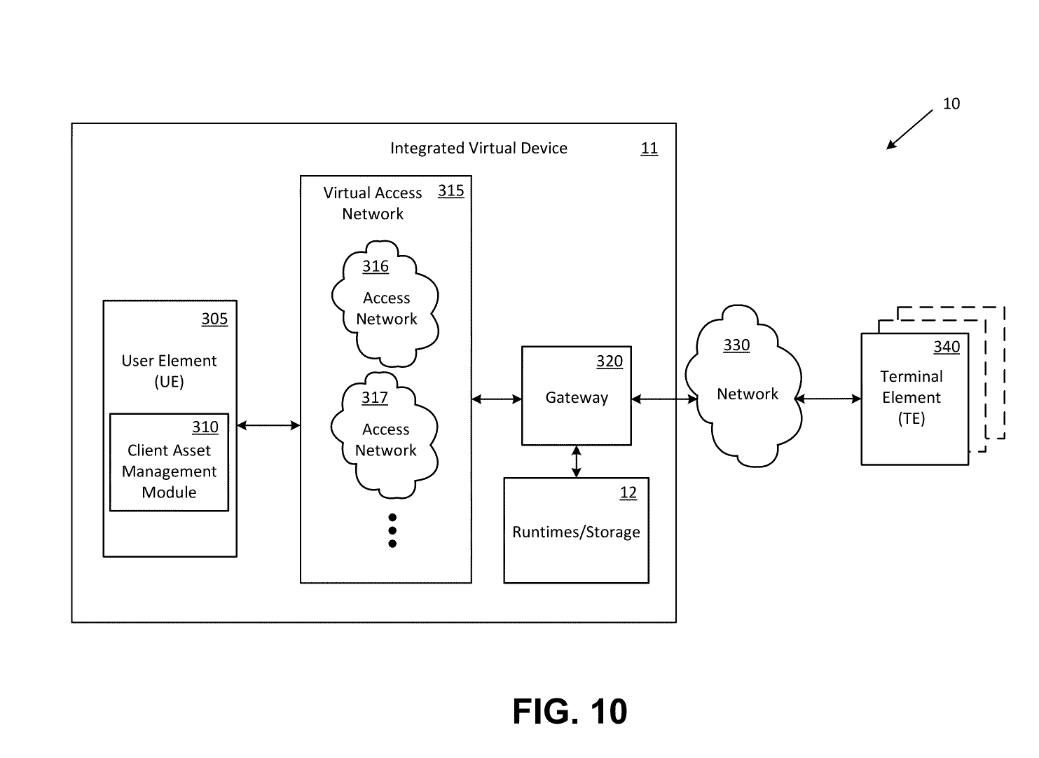

FIG. 10 shows a second exemplary communications system 10 incorporating an integrated virtual device 11 in accordance with the disclosure. The integrated virtual device 11 can constitute a personal cloud architecture wherein the UE 305, the virtual access network 315, the gateway 320 and the runtimes/storage 12 form an integrated system.

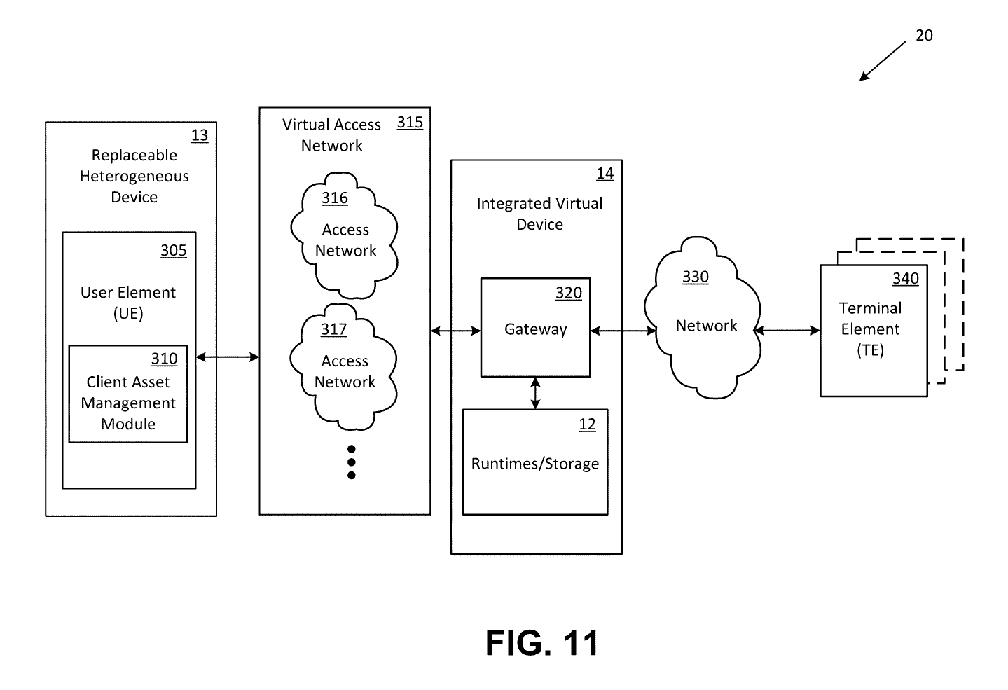

FIG. 11 shows a third exemplary communications system 20 wherein the UE 305 is configured as a replaceable heterogeneous device 13. Communications system 20 can also constitute a personal cloud architecture wherein the gateway 320 and the runtimes/storage 12 can be configured as a virtual device 14.

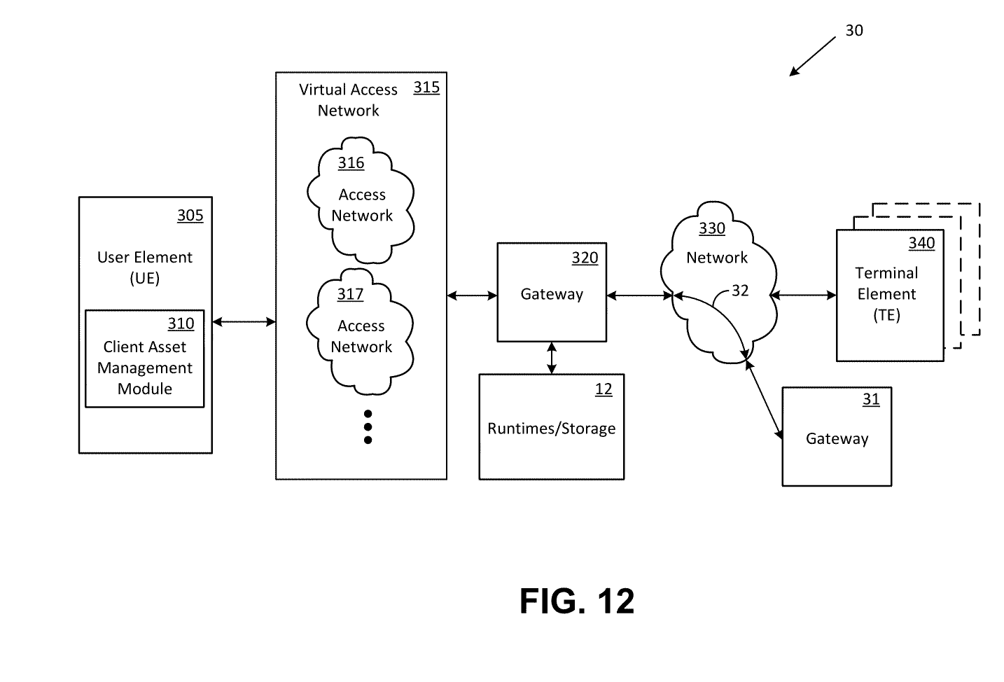

FIG. 12 shows a fourth exemplary communications system 30 wherein metadata annotation is extended to certain portions of an end-to-end data packet path. This enables the efficient deployment of SDN anywhere along the end-to-end data packet path. Attention is drawn to the interconnectivity feature 32 that is provided by the network 330 between the gateway 320 and another gateway 31. The interconnectivity feature 32 incorporates metadata annotation in accordance with the disclosure and enables inter-gateway and gateway-correspondent communications. For example, the gateway 320 can be administered by a network operator and the other gateway 31 can be administered by an enterprise, such that metadata relating to quality-of-service can be processed by the gateway 320 while metadata relating to data security can be processed by the other gateway 31. Some additional aspects and broader descriptions that might be relevant not only to FIG. 12 but to the various other exemplary embodiments described above are provided below. More particularly, provided below are a few exemplary implementations so as to elaborate upon some advantageous features provided in accordance with the disclosure.

For example, in mobile IP applications, the gateway 320 can be used to provide various features that are a part of a Mobile IP Home Agent (IETF standard). The UE 305 can notify the gateway 320 of a release of one or more temporary IP addresses when the UE 305 is powered up, and prior to powering down a network interface of the UE 305. The gateway 320 can use this information to maintain an address mapping and to route data packets to the UE 305 using currently registered, powered up IP addresses.

In some proxy server related implementations, the gateway 320 can be regarded as a proxy server that operates to provide access for the UE 305. The UE 305 can gain access to external ranges of IP addresses via the gateway 320. On the other hand, external correspondents can be precluded from gaining visibility to any access network local IP addresses used by the UE 305.

In some authenticated service related implementations, data packets exchanged by the UE 305 and the gateway 320 can be digitally signed and verified in order to prevent impersonation attacks by nefarious parties. An assigned MAC address to the CAMM can be utilized to facilitate this type of security.

In some implementations related to virtual private networks, data packets exchanged between the UE 305 and the gateway 320 can be signed in order to provide privacy of communications. In these implementations, the gateway 320 can be hosted at the perimeter of an intranet or cloud service provider, and can not only replace a traditional VPN but provide additional advantageous services and features.

In some implementations related to transparent two-way caches, the gateway 320 can incorporate cache storage to provide frequently requested resources to either the UE 305 or in the reverse direction to external correspondents. The gateway 320 can incorporate a content delivery (CDN) component and such content can be pro-actively loaded and stored in one or more UEs such as the UE 305 that are expected to make requests for such content.

In some implementations related to accelerating network access, data traffic traversing the access path segment can be compressed and bandwidth can be shaped in order to provide lower latency, faster throughput and congestion avoidance.

In some implementations related to personal clouds, the gateway 320 can incorporate storage and runtimes to form a network resident personal computer. In this case the UE 305 can employ the gateway 320 as extended cloud storage, as a persistent proxy computer to execute processes requiring fast network bandwidth, and/or to compute power, reliability and other attributes that the UE 305 is unable to compute. Conversely the gateway 320 can employ the UE 305 as a user-interface device.

In some implementations related to addresses, the methods disclosed herein related to providing IP addresses on a system-wide basis can enable both the simplification of the network control plane as well as the scalability of the network.

In some embodiments, each individual end-user of the access service can be provided with a unique gateway instance identified by an IP address. Optionally multiple gateway instances with corresponding IP addresses can be provided per individual end-user. Optionally common IP addresses, but individual port numbers can be assigned for each individual end-user.

In some embodiments, a range of IP addresses can be reserved for a specific group of subscribers, where that grouping is based on a subscription attribute. As an example, subscribers can be divided into “gold”, “silver” and “bronze” categories based on the quality and type of access services. The use of such IP address ranges simplifies the control logic applied to streams of data packets. For example, a single OpenFlow rule can match the entire range of IP addresses of a specific subscriber class.

As shown in FIG. 3, the communications system 300 provides for the UE 305, which can be a smartphone for example, to automatically maintain efficient connectivity to the network 330 (the Internet, for example). The client access management module 310 can be implemented as a component of the smartphone's network stack (network stack 421 shown in FIG. 4). The gateway access manager module 325 can be constructed as a server hardware apparatus that employs an optimized implementation of the access path segment packet processing and a standard network stack as a back-end path segment.

A persistent database, indexed by geographic location can be employed to realize the gateway access manager module 325. The gateway access manager module 325 can track location metadata sent by multiple clients via their respective gateways. The gateway access manager module 325 can provide credentials for use by the discovery and connect module 455 shown in FIG. 4.

In some implementations pertaining to intranet access systems, the gateway 320 can be configured as a VPN gateway, where the back-end interface can provide access to a private intranet domain.

In some implementations, the client component processing rules (see FIG. 7) incorporates routing rules to direct private intranet and public internet packets to separate gateways. Optionally the routing is determined by the specific UE application making the network request.

In some implementations, the intranet access can incorporate a UE device management system to distribute, rotate and revoke encryption keys and authorization of UE devices.

In some implementations pertaining to Software Defined Network (SDN) enabling systems, the use of static gateway IP addresses and annotation of encapsulated packets with metadata can simplify the operation of SDN systems. An SDN system that makes use of the OpenFlow protocol and language, as defined by the Open Networking Foundation (ONF) can be constructed in accordance with the exemplary configuration shown in FIG. 5.

Optionally, the metadata annotation can be employed in certain other segments or in the entire end-to-end packet path, as illustrated on FIG. 12. This enables the efficient deployment of SDN anywhere along this path. Optionally the origin server, or other correspondent, can incorporate a component that performs the annotation function, analogous to the annotation performed by the client and gateway components.

In some implementations pertaining to an Operator Core Network Overlay system, the subscriber manager 710 that is shown in FIG. 7 can be optionally included to enable the enrollment and billing of subscribers. The subscriber manager 710 can maintain a database of subscriber identifiers associated with gateway IP addresses allocated to each subscriber. In some embodiments, the subscriber manager 710 can provide subscriber service parameters, such as traffic volume limits, or quality-of-service policies to be implemented by the gateway 320 and the UE 305.

In some implementations pertaining to cloud services platforms, a cloud platform, such as the iCloud® or the Amazon Cloud Drive® or Salesforce.com®, can provide extended storage and services for various UE devices, such as the iOS© devices of Apple Inc.®. The present disclosure describes methods that can provide persistent, seamless connections between the UE 305 and various cloud servers. The services offered take advantage of the persistent, seamless and secure connection to provide extended storage and application runtimes.

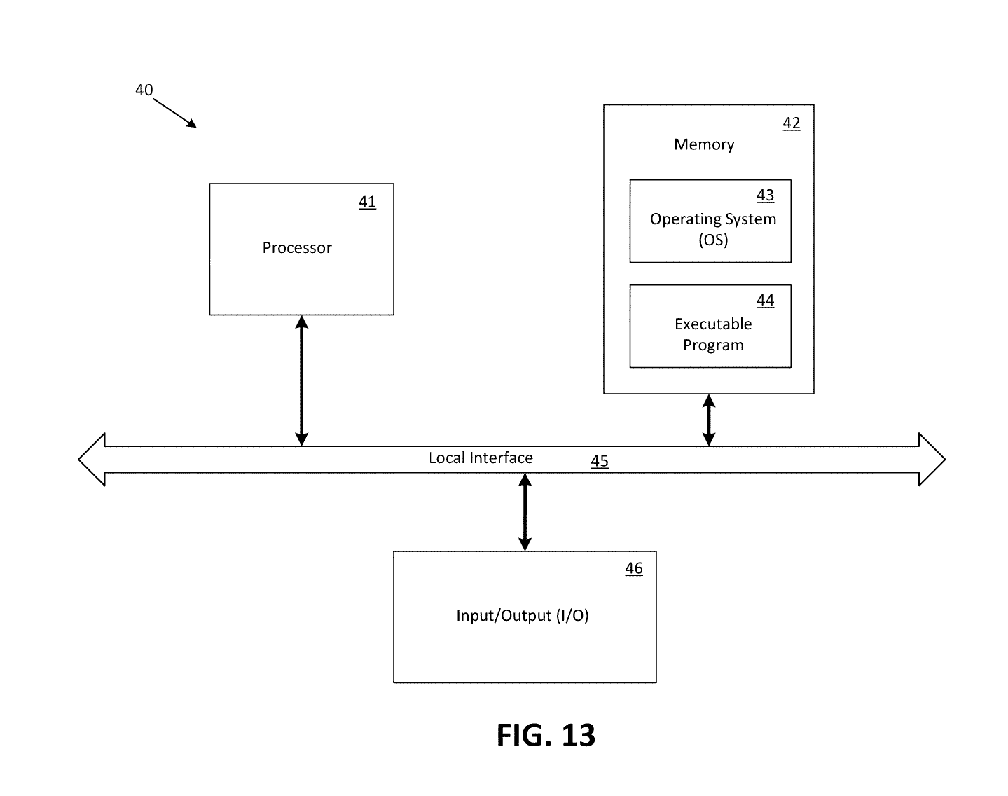

FIG. 13 shows an exemplary embodiment of a target hardware 40 (e.g., a computer system) for implementing the various embodiments described above. The target hardware can comprise a processor 41, a memory bank 42, a local interface bus 45 and one or more Input/Output devices 46. The processor 41 can execute one or more instructions related to the implementation of one or more embodiments described above, and as provided by the Operating System 43 based on an executable program 44 stored in the memory 42. These instructions are provided to the processor 41 via the local interface 45 and as dictated by one or more data interface protocols that can be specific to the local interface 45 and the processor 41. It should be noted that the local interface 45 is a symbolic representation of several elements such as controllers, buffers (caches), drivers, repeaters and receivers that are generally directed at providing address, control, and/or data connections between multiple elements of a processor based system. In some embodiments the processor 41 can be fitted with some local memory (cache) where it can store some of the instructions to be performed for some added execution speed. Execution of the instructions by the processor can include usage of some input/output device 46, such as inputting data from a file stored on a hard disk, inputting commands from a keyboard, inputting data and/or commands from a touchscreen, outputting data to a display, and/or outputting data to a USB flash drive. In some embodiments, the operating system 43 facilitates these tasks by being the central element to gathering the various data and instructions required for the execution of the program and provide these to the processor 41. In some embodiments the operating system 43 might not exist, and all the instructions stored in the memory 42 can be directly executed by the processor 41, although the basic architecture of the target hardware device 41 can remain the same as depicted in FIG. 13. In some embodiments a plurality of processors can be used in a parallel configuration for added execution speed. In such a case, the executable program 44 can be specifically tailored to a parallel execution.

The methods and systems described in the present disclosure can be implemented in hardware, software, firmware or any combination thereof. Features described as blocks, modules or components can be implemented together (e.g., in a logic device such as an integrated logic device) or separately (e.g., as separate connected logic devices). The software portion of the methods of the present disclosure can comprise a computer-readable medium which comprises instructions that, when executed, perform, at least in part, the described methods. The computer-readable medium can comprise, for example, a random access memory (RAM) and/or a read-only memory (ROM). The instructions can be executed by a processor (e.g., a digital signal processor (DSP), an application specific integrated circuit (ASIC), a field programmable logic array (FPGA), a graphic processing unit (GPU), or a general purpose computer processing unit (CPU).

A number of embodiments of the disclosure have been described. Nevertheless, it will be understood that various modifications can be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. For example, although many parts of the disclosure is described in terms of IP layer addresses, the same functionality can be provided for the layer 2 addresses as well. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

What is claimed is:

1. A client access manager module, comprising:
a network interfaces module connected to a plurality of access networks;
the client access manager module configured to:
be loaded on a user element or terminal element of the plurality of access networks;
to aggregate the plurality of access networks into a virtual network; and
receive and interpret network information from a network controller.

2. The client access manager module of claim 1, further comprising:
an applications module configured to execute a plurality of functions producing data;
an encapsulation module configured to encapsulate the data with metadata for network tunneling; and
a controller configured to control the encapsulation module and the network interfaces module such that the plurality of access networks are aggregated into the virtual network;
the network interfaces module being further configured to transmit the encapsulated data on the virtual network.

3. The client access manager module of claim 2, further comprising an operating system connected to the applications module and controlled by the controller.

4. The client access manager module of claim 3, wherein the operating system includes a network stack.

5. The client access manager module of claim 2, further comprising a processing rules module controlled by the controller, the processing rules module configured to provide processing rules for at least one other module of the client access manager.

6. The client access manager module of claim 2, further comprising a shape module controlled by the controller and configured to assign a bandwidth constraint class to the encapsulated data.

7. The client access manager module of claim 2, further configured to one or more of prioritize, compress, encrypt, and annotate the data prior to encapsulation.

8. The client access manager module of claim 7, further comprising a queues module controlled by the controller and configured to process multiple queues generated by the client access manager module from the one or more of prioritize, compress, encrypt, and annotate the data prior to encapsulation.

9. The client access manager module of claim 1, further comprising a discovery and connect module connected to the network interfaces module.

10. The client access manager module of claim 1, wherein the network information modifies rules of the programming rules module.

11. A communications system comprising:
a user element loaded with the client access manager module of claim 1;
a plurality of network elements networked with the user element via a plurality of access networks;
a network controller controlling the plurality of network elements and communicating network information to the user element;
a gateway connected to the plurality of network elements, the gateway configured to route control data from the controller to the user element; and
a terminal element networked to plurality of network elements via the gateway,
wherein communication between the user element and the terminal element is provided by virtual transmission links on the virtual network.

12. The communications system of claim 11, wherein the gateway is configured to provide an interconnectivity feature that uses metadata in the encapsulated data.

13. The communications system of claim 12, wherein the metadata comprises data for at least one of direct sensory readings, inferred parameters related to the user element, environment behavior, and end-user behavior.

14. The communications system of claim 11, wherein the virtual network includes virtual servers.

15. The communications system of claim 11, wherein the network controller further comprises controlling the user element by modifying programming rules of the client access manager module.

16. A method for controlling a virtual network between a user element and a terminal element, the method comprising:
sending network data, from a network controller, to the user element by communication with a client access manager module loaded on the user element; and
routing, by a gateway, the network data from the network controller to the user element.

17. The method of claim 16, wherein the network data comprises information about network conditions.

18. The method of claim 16, wherein the network data comprises control commands to the client access manager module that modify programming rules.

19. The method of claim 16, further comprising:
encapsulating, by the client access manager module, data for the terminal element with metadata for network control;
aggregating a plurality of access networks having connection to the terminal element into a virtual network; and
controlling a plurality of network elements used by the virtual network with a network controller.

20. The method of claim 16, further comprising providing a backup tunnel connection between the user element and the terminal element.
